(19) United States
(12) Patent Application Publication
(10) Pub. No.: US 2002/0032662 A1
(43) Pub. Date: Mar. 14, 2002

(54) System and method for servicing secure credit/debit card transactions

(76) Inventors: Roland Martin Maclin, Houston, TX (US); Michel Monique Burrage, Houston, TX (US)

Correspondence Address: Timothy W. Markison, P.O. Box 342019, Austin, TX, 78734, US

(21) Appl. No.: 09/945,993

(22) Filed: Sep. 4, 2001

Related U.S. Application Data
(60) Provisional application No. 60/229,024, filed on Aug. 30, 2000.

(51) Int. Cl. G06F 17/60

(52) U.S. Cl. 705/64

(57) ABSTRACT

A method and an apparatus for securing e-commerce transactions include processing that begins by receiving a customer package of variables regarding a desired secure e-commerce transaction. The processing continues by validating the desired secure e-commerce transaction based on at least one item of the package of variables. If the desired secure e-commerce transaction is validated, the processing continues by generating a temporary credit card number for the desired secure e-commerce transaction based on the at least one item of the package of variables. Once the temporary credit card number is generated, the processing continues by providing the temporary credit card number for use in the desired secure e-commerce transaction.

### TECHNICAL FIELD OF THE INVENTION

The present invention relates generally to electronic commerce and more particularly to the servicing of a credit/debit card transactions in a secure manner.

### BACKGROUND OF THE INVENTION

Credit and debit cards (hereinafter referred to singularly as “credit cards”) have become a predominant manner in which to pay for consumer based transactions. As is widely known, a credit card subscriber is issued a plastic credit card that contains a number of types of information. First, the subscriber's name is embossed into the plastic credit card. Further, the subscriber's particular credit card number and expiration date of the credit card are also embossed into the credit card. Other information regarding the subscriber may also be embossed into the credit card as well.

The name and contact information of the servicing organization is also typically printed on the credit card. The credit card number not only identifies the particular subscriber's account but also the servicing organization. The servicing organization is typically a bank or other lending institution organized to service credit card transactions. Subscriber and servicing organization information is also encoded in a magnetic strip contained on the credit card. A magnetic strip card reader may access this information.

During a credit card transaction within a conventional store, an attendant via a visual inspection and also using an on-line credit card transaction device authorizes the credit card. During the credit card transaction, the credit card is passed through the credit card transaction device and the attendant enters additional information into the device regarding the particular transaction. The credit card transaction device places a data call to a servicing organization computer to validate the transaction.

During this validation operation, an investigation is made with regard to the subscriber's account and the status of the credit card. If the subscriber has failed to comply with his or her obligations, or the credit card is stolen, the servicing organization will place this information into the servicing organization computer and this information will be reported to the credit card transaction device. Based upon this information, the attendant will typically refuse to complete the transaction, perhaps requiring the customer to pay by other means. This type of transaction validation operation protects not only the servicing organization but will protect the subscriber if his or her card is lost or stolen.

The popularity and use of the Internet (World-Wide-Web “WWW”) continues to increase dramatically. While electronic commerce (e-commerce) across the Internet is a relatively recent development, e-commerce sales already represent a substantial portion of overall sales. Internet sales are predominantly serviced using credit cards. Unfortunately, during an Internet transaction, various problems exist with regard to the credit card transaction. First, the purchaser must provide his or her credit card number across the Internet to an e-commerce seller. During this process, the credit card number may be intercepted. Further, in many e-commerce transactions, the purchaser provides a credit card number to the seller, which is subsequently stored on the seller's web server. The seller's web server may be illegally accessed and the credit card number taken. For these reasons, many consumers will not complete their e-commerce transactions via the Internet.

In an attempt to reduce these risks, the customers may initiate a telephone call in which they provide their telephone number to the seller. However, once the seller has the credit card number, the seller may place the credit card number on a computer that is subject to illegal access. Thus, providing a credit card number to the seller via the telephone does not overcome all of the problems associated with e-commerce transactions serviced by credit card payment. Further, these problems also exist in those systems used by sellers that service both telephone orders and Internet orders but that store credit card information in a common database that is accessible via a computer network.

Thus, there is a need in the art for a system and method that will remove risks associated with e-commerce and that will allow customers to transact their business across the Internet even when they are selecting goods and services that require significant intelligence in the selection process.

### BRIEF DESCRIPTION OF THE DRAWINGS

FIG. 1 illustrates a block diagram of a system for supporting secure credit/debit card transactions according to the present invention;

FIG. 2 illustrates a logic diagram of a method for setting up a system according to the present invention;

FIG. 3 illustrates a logic diagram of a method for a customer computer to facilitate a secure transaction according to the present invention;

FIG. 4 illustrates a logic diagram for a method for a credit card server computer to facilitate a secure transaction according to the present invention;

FIG. 5 illustrates a logic diagram of a method for processing a secure e-commerce transaction according to the present invention;

FIG. 6 illustrates a logic diagram of a more detailed method for detecting the initiation of a secure e-commerce transaction of the method of FIG. 5;

FIG. 7 illustrates a logic diagram of a more detailed method for providing the customer package to the server of the method of FIG. 5;

FIG. 8 illustrates a logic diagram of a more detailed method for receiving the customer package of the method of FIG. 5;

FIG. 9 illustrates a logic diagram of a more detailed method for validating the desired secure e-commerce transaction of FIG. 5;

FIG. 10 illustrates a logic diagram of an alternate and more detailed method for validating the desired secure e-commerce transaction of FIG. 5;

FIG. 11 illustrates a logic diagram of a more detailed method for generating the temporary credit card number of FIG. 5; and

FIGS 12 and 13 illustrate a schematic block diagram and state diagram of a secure e-commerce transaction according to the present invention.

### DETAILED DESCRIPTION OF A PREFERRED EMBODIMENT

Generally, the present invention provides a method and apparatus for securing e-commerce transactions. Such a method and an apparatus include processing that begins by receiving a customer package of variables regarding a desired secure e-commerce transaction. The customer package of variables includes, but is not limited to one or more of, a customer account number, a desired amount of the desired secure e-commerce transaction, identity of an e-commerce merchant, merchant account number, a password, and a login name. The processing continues by validating the desired secure e-commerce transaction based on at least one item of the package of variables. If the desired secure e-commerce transaction is validated, the processing continues by generating a temporary credit card number for the desired secure e-commerce transaction based on the at least one item of the package of variables. Once the temporary credit card number is generated, the processing continues by providing the temporary credit card number for use in the desired secure e-commerce transaction. With such a method and apparatus, a credit card transaction can be securely processed via the World Wide Web.

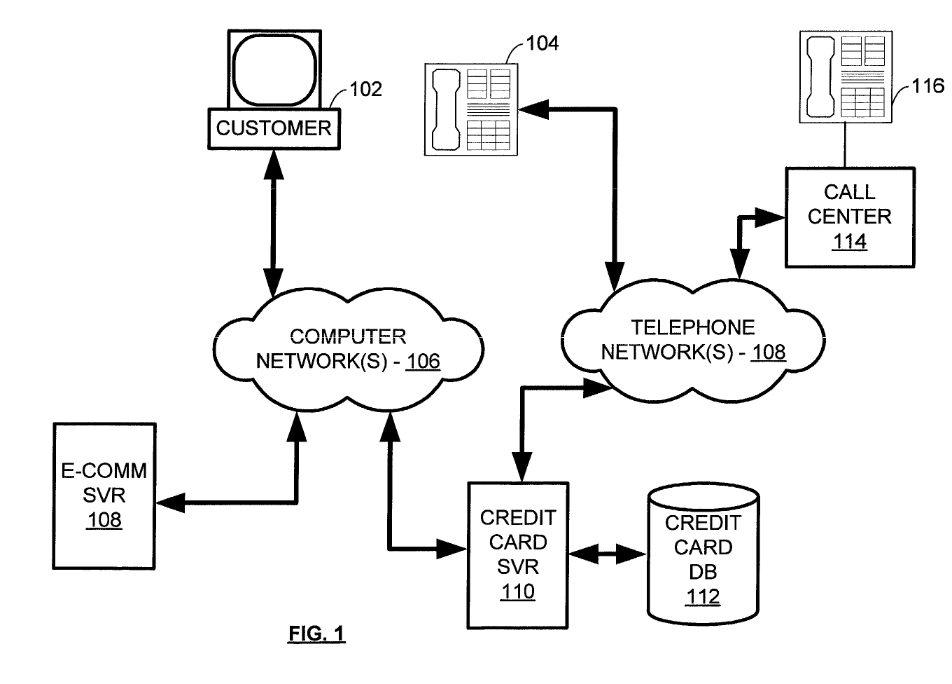

The present invention can be more fully described with reference to the FIG. 1—. FIG. 1 is a diagram illustrating a system for supporting secure credit/debit card transactions according to the present invention. As shown in FIG. 1, the system includes a customer computer 102 and a customer telephone 104. The customer computer couples to at least one computer network 106, which may include one or more of the Internet, local area networks, wide area networks, global area networks, and other networks that support computer-to-computer communications (collectively referred to as the “Internet” or “computer networks”). Also coupled to the computer networks 106 is an e-commerce server 108 that supports e-commerce (Internet) transactions.

Further, a credit card server 110 couples to the computer networks 108, the credit card server 110 servicing credit card/debit card transactions. In servicing the credit card/debit card transactions, the credit card server 110 performs both real-time transaction validation as well as transaction clearinghouse operations. The credit card server 110 is coupled to a credit card database 112 that stores data to enable operation according to the present invention as well as additional serviced operations.

The customer telephone 104 couples to a telephone network 108, such as the Public Switched Telephone Network, the Integrated Services Digital Network, or other networks that support telephone-like voice communications. A call center 114 that includes at least one attendant terminal 116 also couples to the telephone network 108. The call center 114 services telephone based transactions such as catalog sales and those transactions that are initiated via the Internet but completed via a telephone call. The credit card server 110 also couples to the telephone network 108 and may service credit card transactions via the telephone network 110.

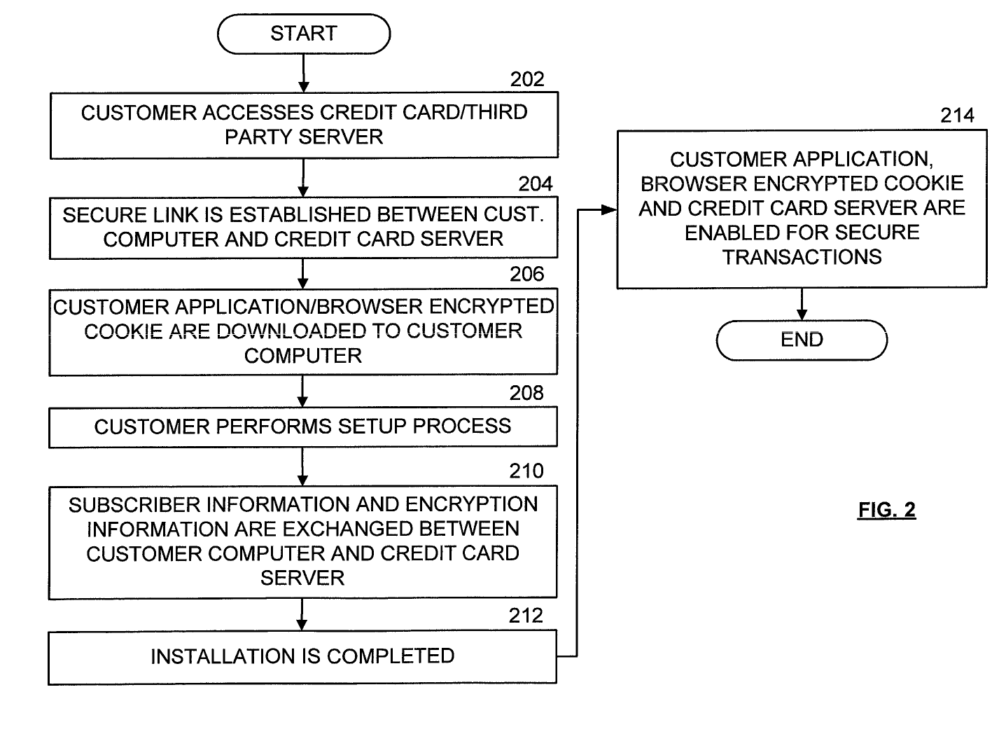

FIG. 2 is a logic diagram illustrating the setup of a system according to the present invention. In setting up the system of the present invention, the customer accesses the credit card server 110 (or a third party computer that services the setup operations) via his or her customer computer 102 and the Internet 106 (step 202). Once access has been granted, a secure link is established between the customer computer 102 and the credit card server 110 (step 204). Over this secure link, the credit card server 110 downloads a customer application and a browser encrypted cookie to the customer computer 102 (step 206). This software then enables the customer to complete the setup process (step 208). During this setup process, the customer provides his or her credit card number, expiration date, personal information and additional information that will enable subsequent operations according to the present invention.

This subscriber information and additional information that will be employed in subsequent encryption/decryption operations is then exchanged between the customer computer 102 and the credit card server 110 across the secure link enabled by the Internet 106. After this exchange of information concludes, the installation is completed (step 212) and the customer application, browser encrypted cookie and credit card server 110 are enabled to service subsequent customer credit card transactions.

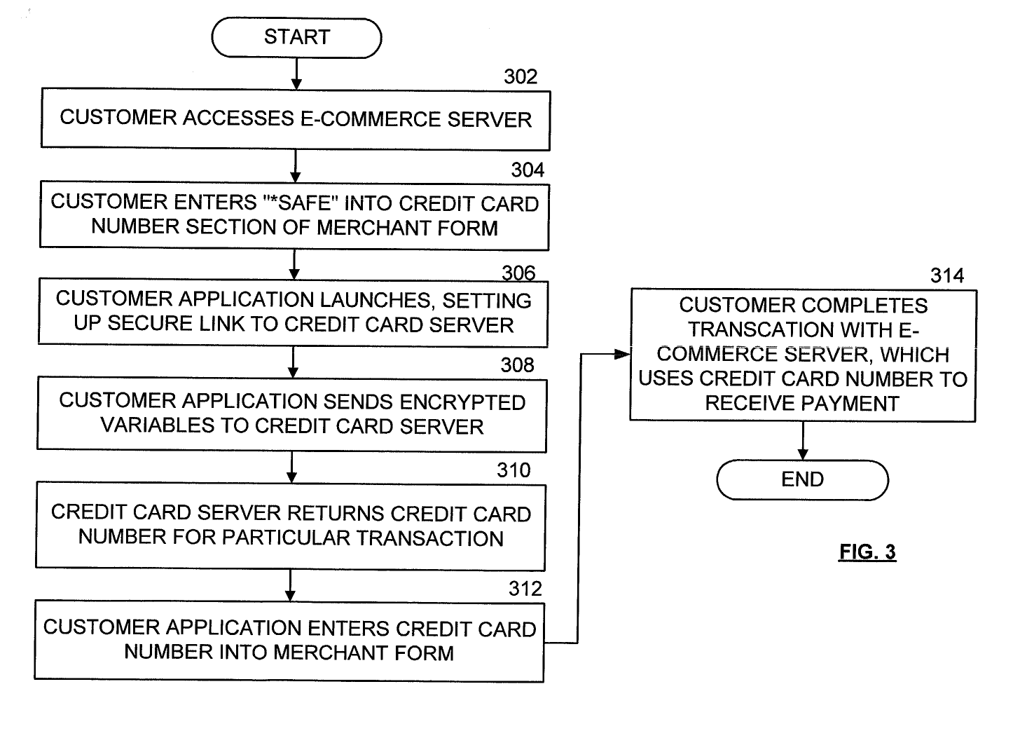

FIG. 3 is a logic diagram illustrating customer computer operations according to the present invention. The operations described with reference to FIG. 3 are those operations performed substantially by the customer application and browser encrypted cookie. Operations performed substantially by the credit card server are discussed with reference to FIG. 4. Further, the particular operations described with reference to FIGS. 3 and 4 relate to an Internet enable transaction. However, after the description of these operations is completed, the manner in which the present invention applies to telephonic transactions will be discussed.

In a first operation of FIG. 3, the customer accesses the e-commerce server 108 via the Internet 106 using his or her customer computer 102 (step 302). In accessing the e-commerce server 108, the customer seeks to purchase a good or service on-line, using his or her credit card to pay for such good or service. Thus, in response, the e-commerce server provides a transaction web page to the customer on the customer computer 102, requiring entry of a credit card number, and other relevant credit card information. However, instead of entering his or her credit card number in the required field, the customer instead enters the string “*SAFE”, or another designated string (step 304). When this string is entered, the customer application is launched.

Upon being launched, the customer application sets up a secure link to the credit card server 110 (step 306), the secure link established using information that was obtained during the setup process described with reference to FIG. 2. After the secure link is established, the customer application running on the customer computer 102 sends encrypted variables to the credit card server 110 (step 308). After a processing time, the credit card server 110 returns a credit card number to the customer computer 110 that will be used for the current transaction (step 310). This credit card number arrives in an encrypted form that is then decrypted by the customer application running on the customer computer 102. The customer application then enters the returned credit card number into the credit card field of the e-commerce merchant form (312). The customer application may enter other information into other fields of the e-commerce merchant form as is required. Then, with the e-commerce merchant form completed, the customer transmits the information to the e-commerce server 108 to complete the transaction (step 314).

FIG. 4 is a logic diagram illustrating credit card server computer operations according to the present invention, from the perspective of the credit card server 110. Prior to initiation of the operations of FIG. 4, a customer has setup operations in conjunction with the credit card server 110, as was previously described with reference to FIG. 2. The operation of FIG. 4 thus commences when the credit card server 110 receives a request from a customer application running on a customer computer 102 (step 402). In response to the request, the credit card server 110 establishes a secure link across the Internet 106 with the customer computer 102.

With the secure link established across the Internet 106, the credit card server 110 receives a package of variables from the customer computer 102. This package of variables may include the customer's account number, a desired amount of the transaction at issue, the e-commerce merchant's identity or account number, a password, a login, and other additional information). The credit card server 110 then decrypts these received variables. The credit card server 110 then validates the customer's credit card account to determine whether the customer may proceed with the transaction. If so, operation continues. If not, operation ceases and the credit card server 110 returns an error message to the customer computer 102.

Next, the credit card computer 110 generates a temporary credit card number that will service the particular transaction and a package of variables to be returned to the customer computer 102 (step 410). The credit card server 110 stores relevant portions of this information in its database 112 (step 412). Then, it encrypts the package of information and returns the encrypted information to the information to the customer computer 102 (step 414).

After the customer uses the temporary credit card number to pay for his e-commerce purchase, the e-commerce merchant processes the transaction information and seeks payment from the credit card company via the credit card server 110 (or other means). When this occurs, the merchant presents the temporary credit card number to the credit card server 110 along with the other transaction information. The credit card server 110 processes this information against the information it previously stored in its database 112 (step 416). If the transaction proves to be valid, the merchant is paid and the transaction is billed to the customer.

The present invention may also be employed to service a call center 114 transaction. In such case, steps 306 through 310 of FIG. 3 and all of the steps of FIG. 4 are performed to provide the customer with a temporary credit card number. The customer receives this temporary credit card number and presents the temporary credit card number to an attendant of the call center 114 to complete the transaction.

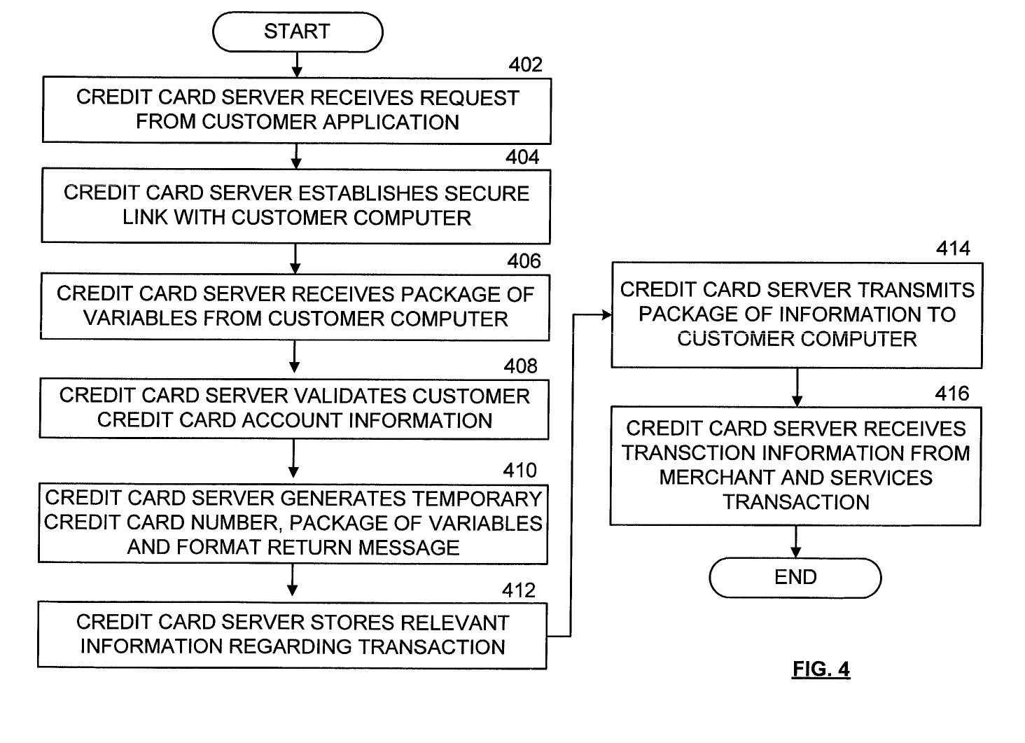

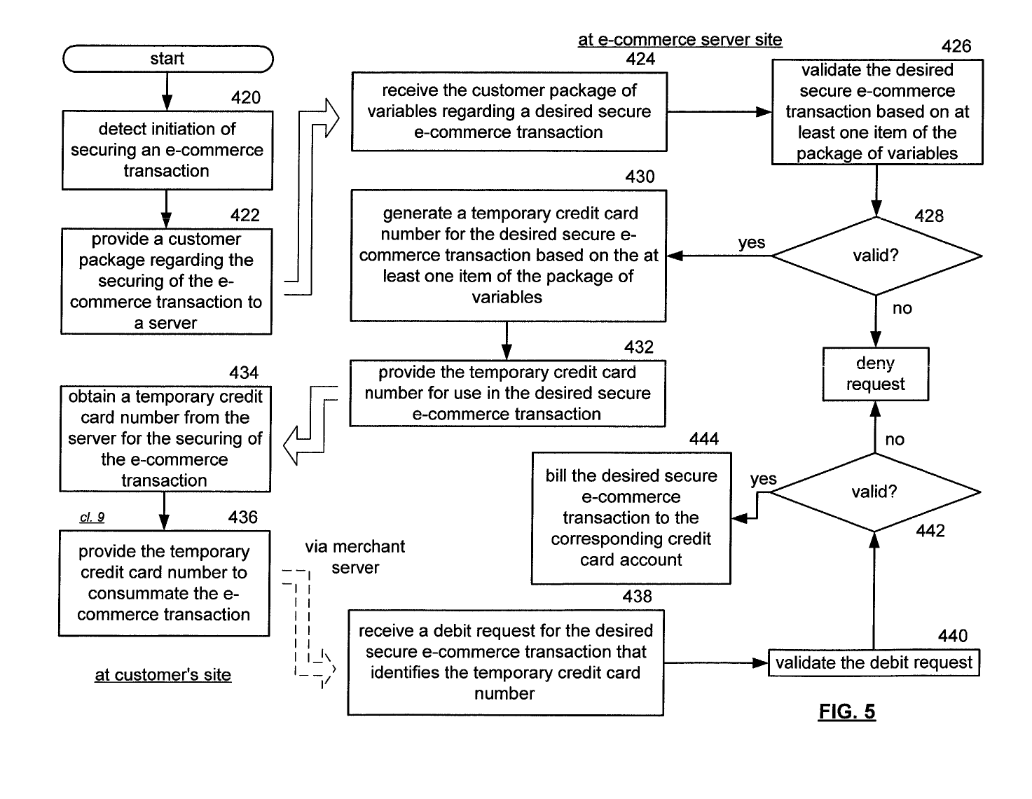

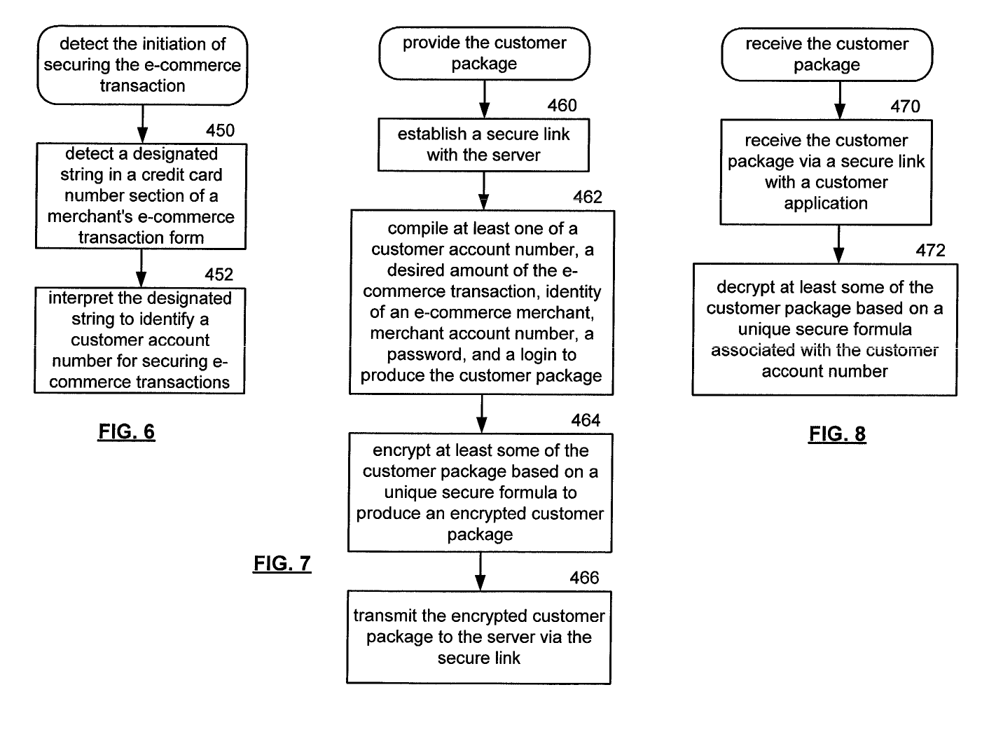

FIG. 5 illustrates a logic diagram of a method for processing a secure e-commerce transaction via the Internet and/or communication networks. The process begins at the customer site, where, at step 420, initiation of securing an e-commerce transaction is detected, which is described in greater detail with reference to FIG. 6. The process then proceeds to step 422 where a customer package regarding the securing of the e-commerce transaction is provided to a server (e.g., server 108 and/or 110). The providing of the customer package will be discussed in greater detail with reference to FIG. 7.

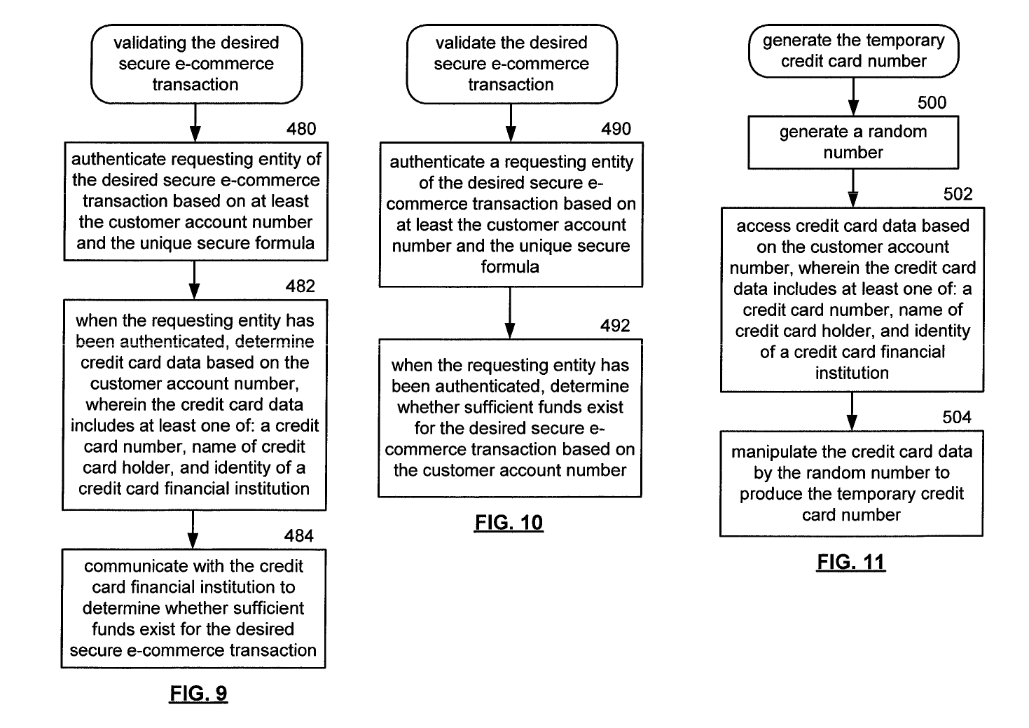

The processing now proceeds to the server site, where, at step 424, the server receives the customer package of variables regarding the desired secure e-commerce transaction. The receiving of the customer package will be described in greater detail with reference to FIG. 8. The process then proceeds to step 426 where the server validates the desired secure e-commerce transaction based on at least one item of the package of variables. Validation of the transaction will be alternatively discussed in greater detail with reference to FIGS. 9 and 10. When the secure e-commerce transaction is not validated, it is denied.

When the desired secure e-commerce transaction is validated, the process proceeds to step 430, where the server generates a temporary credit card number for the desired secure e-commerce transaction based on the at least one item of the package of variables. The generation of the temporary credit card number will be discussed in greater with reference to FIG. 11. The process then proceeds to step 432 where the server provides the temporary credit card number for use in the desired secure e-commerce transaction.

Returning to the customer site, the process proceeds to step 434, where the customer obtains the temporary credit card number from the server for the securing of the e-commerce transaction. The process then proceeds to step 436 where the customer provides the temporary credit card number to consummate the e-commerce transaction. The temporary credit card number may be provided to the merchant's server by entering the number in the credit card number section of the merchant's e-commerce transaction form.

The process then reverts back to the server site, where, at step 438, the server receives a debit request for the desired secure e-commerce transaction from the merchant's server. The debit request identifies the temporary credit card number, the cardholder name, the amount of the transaction, and/or an expiration date of the card. The process then proceeds to step 440, where the server validates the debit request. If, at step 442, the debit request is not valid, the request is denied.

If, however, at step 442, the debit request is valid, the process proceeds to step 444 where the server bills the desired secure e-commerce transaction to the corresponding credit card account. Note that if the secure e-commerce server is inclusive of the financial institution server, the billing of the customer account is done locally. If, however, the financial institution server is a separate server than the e-commerce server, then the e-commerce server would communicate with the financial institution server to provide the debiting information to the financial institution server.

FIG. 6 illustrates a more detailed method of detecting the initiation of the e-commerce transaction. The processing begins at step 450 where the customer computer detects a designated string in a credit card number section of a merchant's e-commerce transaction form. The designated string may be any code, name, numerical sequence, etc., that the user of the customer computer desires to function as the imitation of secure e-commerce transaction. The processing the proceeds to step 452 where the customer computer interprets the designated string to identify a customer account number for securing e-commerce transactions.

FIG. 7 illustrates a logic diagram of a method for providing the customer package from the customer computer to the server. The process begins at step 460 where the customer computer establishes a secure link with the server. This may be done using known techniques for securing a communication link, via the Internet or communication network, between two computers. The process then proceeds to step 462 where the customer computer compiles a customer account number, a desired amount of the e-commerce transaction, identity of an e-commerce merchant, merchant account number, a password, and/or a login to produce the customer package.

The process then proceeds to step 464 where the customer computer encrypts at least some of the customer package based on a unique secure formula to produce an encrypted customer package. The unique secure formula may be a predetermine arithmetic function known only by the customer computer and the server, it may be a public and private key pair, it may be symmetric key, and/or any type of encrypting data for transmission via the Internet, including, but not limited to, SSL, PPP. The process then proceeds to step 466 where the customer computer transmits the encrypted customer package to the server via the secure link.

FIG. 8 illustrates a logic diagram of method for the server to receive the customer package. The process begins at step 470 where the server receives the customer package via the secure link with a customer application, i.e., an application running of the customer computer. The customer package includes a customer account number, a desired amount of the desired secure e-commerce transaction, identity of an e-commerce merchant, merchant account number, a password, and/or a login ID. The process then proceeds to step 472 where the server decrypts at least some of the customer package based on a unique secure formula associated with the customer account number.

FIG. 9 illustrates a logic diagram of the method for the server to validate the secure e-commerce transaction request. The processing begins at step 480 where the server authenticates the requesting entity (i.e., the application running on the customer computer) of the desired secure e-commerce transaction based on at least the customer account number and the unique secure formula. The processing continues at step 482 where the server determines credit card data based on the customer account number when the requesting entity has been authenticated. The credit card data includes a credit card number, name of credit card holder, and/or identity of a credit card financial institution.

The processing continues at step 484 where the server communicates with the credit card financial institution to determine whether sufficient funds exist for the desired secure e-commerce transaction. As one of average skill in the art will appreciate, such communication would be between the server and a server of the financial institution via a dedicated, or virtually dedicated, private and secure communication path. The data exchanged between the server and the server of the financial institution may be clear data and/or encrypted.

FIG. 10 illustrates a logic diagram of an alternate method for the server to validate the secure e-commerce transaction request. In this method, the e-commerce server and the financial institution server are one in the same, and/or collated such that communication between the servers is not done via the Internet, or other type of communication network. The process begins at step 490 where the server authenticates a requesting entity of the desired secure e-commerce transaction based on at least the customer account number and the unique secure formula. The process then proceeds to step 492 where the server determines whether sufficient funds exist for the desired secure e-commerce transaction based on the customer account number when the requesting entity has been authenticated. In this instance, the customer account number identifies at least one of: a credit card number, name of credit card holder, expiration date, credit status, and available funds.

FIG. 11 illustrates a logic diagram of method for generating the temporary credit card number. The process begins at step 500, where the server generates a random number. The process then proceeds to step 502 where the server accesses credit card data based on the customer account number. As mentioned, the credit card data includes a credit card number, name of credit card holder, and/or identity of a credit card financial institution. The process then proceeds to step 504 where the server manipulates the credit card data by the random number to produce the temporary credit card number. As one of average skill in the art will appreciate, many techniques may be employed to generate the temporary credit card number, including, but not limited to, scrambling the data, encrypting the data, performing a mathematical function upon the data, using all of the data, and/or using only various selected and/or random portions of the data.

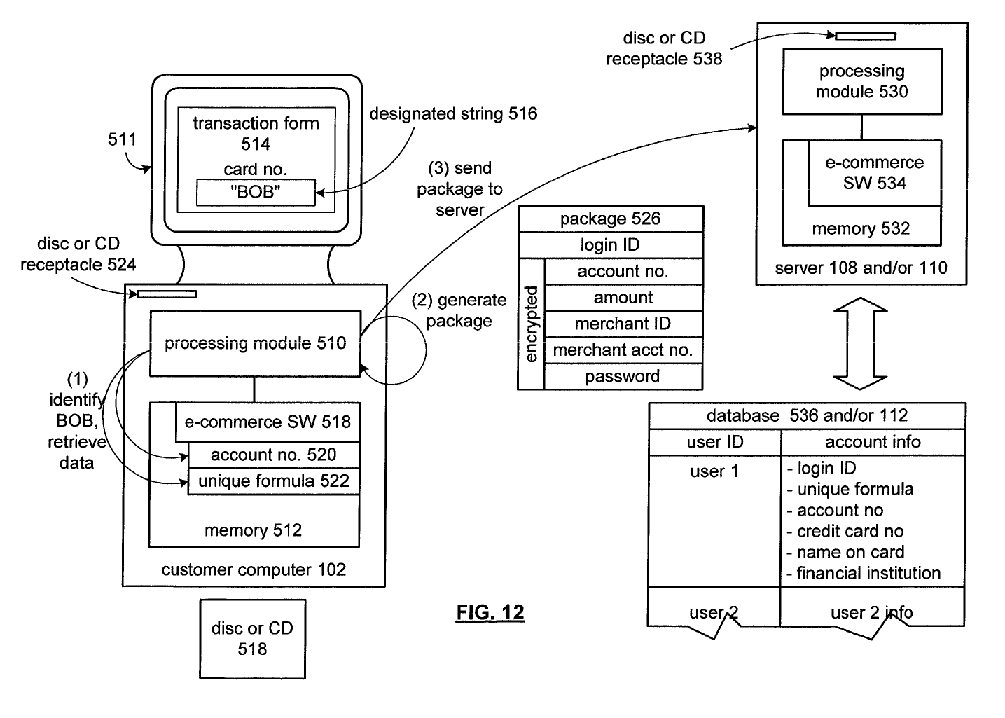

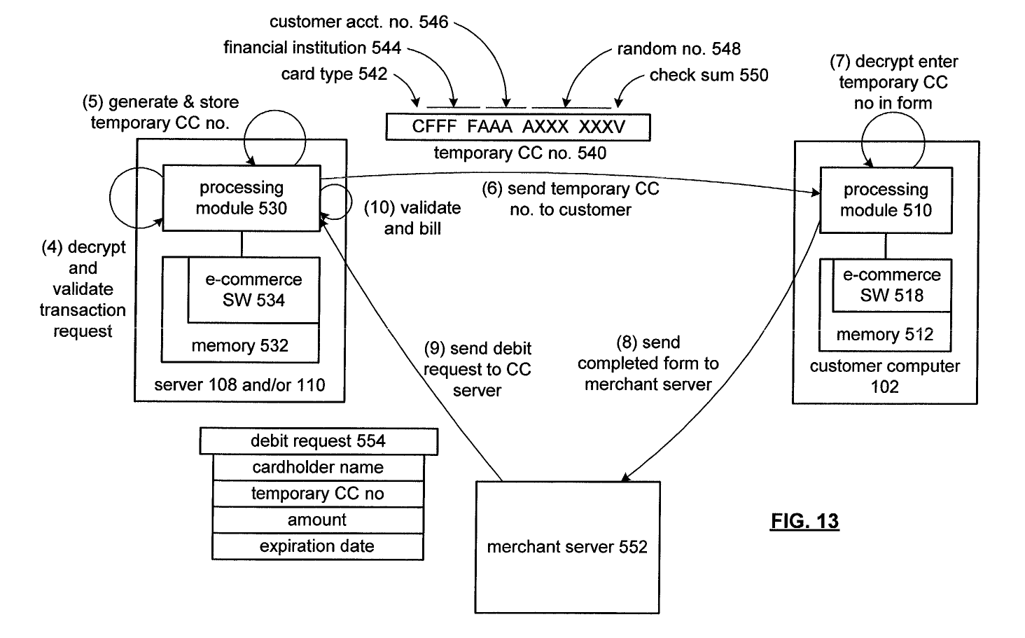

FIGS. 12 and 13 illustrate a combined schematic block diagram and state diagram of securing an e-commerce transaction. As shown, the customer computer 102 includes a monitor 511, a processing module 510, and memory 512. The processing module 510 may be a single processing device or a plurality of processing devices. Such a processing device may be a microprocessor, microcontroller, digital signal processor, state machine, logic circuitry, programmable gate array, analog circuitry, and/or any device that manipulates signals (analog or digital) based on operational instructions. The memory 512 may be a single memory device or a plurality of memory devices. Such a memory device may be a read only memory, random access memory, re-programmable memory, system memory, magnetic tape memory, and/or any device that stores digital information. Note that when the processing module 510 implements one or more of its functions via a state machine, logic circuitry, and/or analog circuitry, the memory storing the corresponding instructions is embedded within the circuitry comprising the state machine, logic circuitry, and/or analog circuitry. The operational instructions stored in memory 510 and performed by processing module 512 have been discussed with reference to FIGS. 2 through 11.

The server 108 and/or 110 includes a processing module 530 and memory 532. The processing module 530 may be a single processing device or a plurality of processing devices. Such a processing device may be a microprocessor, microcontroller, digital signal processor, state machine, logic circuitry, programmable gate array, analog circuitry, and/or any device that manipulates signals (analog or digital) based on operational instructions. The memory 532 may be a single memory device or a plurality of memory devices. Such a memory device may be a read only memory, random access memory, re-programmable memory, system memory, magnetic tape memory, and/or any device that stores digital information. Note that when the processing module 510 implements one or more of its functions via a state machine, logic circuitry, and/or analog circuitry, the memory storing the corresponding instructions is embedded within the circuitry comprising the state machine, logic circuitry, and/or analog circuitry. The operational instructions stored in memory 530 and performed by processing module 532 have been discussed with reference to FIGS. 2 through 11.

As further shown, both the computer 102 and the server 108 and/or 110 include a disc and/or CD receptacle 524 and 538. Also shown is a digital storage device, such as a disc or CD, which may store the e-commerce software 518 and/or 534. If so, the computer and server may read the operational instructions from the disc and/or CD as opposed to reading them from local memory. Further, the information on the disc and/or CD 518 may be copied on to local memory 512 and/or 532 for subsequent e-commerce transaction processing.

In operation, the customer computer supports secure e-commerce transactions via e-commerce software 518, which is stored in memory 512 and executed by the processing module 510. For a given secure e-commerce transaction, the user of the customer computer enters a designated string 516 in to credit card number section of the e-commerce merchant's form 514. In this example, the string is “BOB”. When the processing module detects “BOB” in the form 514, it retrieves an e-commerce secure account number 520 and a unique formula. Having done this and in accordance with the e-commerce software, the processing module generates a customer package 526.

As shown, the customer package 526 includes a login ID, which may or may not be encrypted, the account number, the amount of the secure transaction, the merchant's ID, the merchant's account number, and a password. Some or all of this data may be encrypted using the unique formula 522. The secured customer is package 526 is sent to the server 108 and/or 110 via a secure link. The secure link is established as previously described.

The server, upon receiving the package, executes its e-commerce software 534 to identify the user. As shown, the server 108 and/or 110 is operably coupled to a database, which may be database 102 and/or a separate database for secure e-commerce transactions. The database includes a user ID field and an account information field. The user ID field identifies a particular user, e.g., the user of the customer computer 102. For each user, the database includes account information such as, but not limited to, a login ID, unique formula, account number, credit card number, cardholder name, and financial institution. Note that the package 526 sent from the user to the server does not include the customer's credit card number or other personal information. The information contained in the package 526 identifies the user and his credit card information. As such, a great deal of security is obtained by not transmitting the actual credit card information via the Internet.

The example continues on FIG. 13 where the server 108 and/or 110 decrypts the package using the unique formula associated with the given user. This information is retrieved from the database. Once the package is decrypted, it is validated. The validation includes, but is not limited to, authenticating the user based on the data in the package matching the data in the database for the given user, determining that the user has sufficient funds for the transaction, determining that the user is in good standing to use the credit card, and/or in good standing to use the securing services. If the request is validated, the server generates a temporary credit card number 540.

The temporary credit card number 540 includes the same number of digits that a traditional credit card includes, i.e., 16. As shown, the first number C identifies the type of card 542 (e.g., Visa, Master card, etc.), the next for digits FFFF identify the financial institution 544, the next four digits AAAA identify the customer's account number 546, the next six digits XXXXXX represent a random number 548, and the last digit V represents a check sum 550. As one of average skill in the art will appreciate, more or less digits may be used for the customer account number and the random number sections. In addition, all or a portion of the digits may represent an encoded temporary credit card number. Accordingly, the server would need to identify the type of encoding used and the particular transaction the temporary credit card number was used for to bill the appropriate account and credit to appropriate merchant.

The server sends the temporary credit card number, in an encrypted form via the secure communication link, to the customer computer 102. The customer computer 102 decrypts the temporary credit card and enters it into the form 514. At this point, the completed form 514 is sent to the merchant's server 552, which sends a debit request 554 to the server 108 and/or 110. The debit request 554 includes the name of the cardholder, the temporary credit card number, the amount of the transactions, merchant ID, merchant account information, and/or expiration date of the card. The server validates the debit amount by accessing the database to confirm that the given user did in fact receive a temporary credit card number to purchase items for a particular merchant at a particular price. If this information checks, the server bills the customer's credit card account either directly or through a financial institution.

The invention disclosed herein is susceptible to various modifications and alternative forms. Specific embodiments therefor have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

What is claimed is:

1. A method for secure e-commerce transactions, the method comprises:
receiving a customer package of variables regarding a desired secure e-commerce transaction;
validating the desired secure e-commerce transaction based on at least one item of the package of variables;
when the desired secure e-commerce transaction is validated, generating a temporary credit card number for the desired secure e-commerce transaction based on the at least one item of the package of variables; and
providing the temporary credit card number for use in the desired secure e-commerce transaction.

2. The method of claim 1 further comprises:
receiving a debit request for the desired secure e-commerce transaction, wherein the debit request identifies the temporary credit card number;
validating the debit request; and
when the debit request is valid, billing the desired secure e-commerce transaction to the corresponding credit card account.

3. The method of claim 1, wherein the receiving the customer package further comprises:
receiving the customer package via a secure link with a customer application, wherein the customer package includes at least one of: a customer account number, a desired amount of the desired secure e-commerce transaction, identity of an e-commerce merchant, merchant account number, a password, and a login; and
decrypting at least some of the customer package based on a unique secure formula associated with the customer account number.

4. The method of claim 3, wherein the validating the desired secure e-commerce transaction further comprises:
authenticating requesting entity of the desired secure e-commerce transaction based on at least the customer account number and the unique secure formula;
when the requesting entity has been authenticated, determining credit card data based on the customer account number, wherein the credit card data includes at least one of: a credit card number, name of credit card holder, and identity of a credit card financial institution; and
communicating with the credit card financial institution to determine whether sufficient funds exist for the desired secure e-commerce transaction.

5. The method of claim 3, wherein the validating the desired secure e-commerce transaction further comprises:
authenticating a requesting entity of the desired secure e-commerce transaction based on at least the customer account number and the unique secure formula; and
when the requesting entity has been authenticated, determining whether sufficient funds exist for the desired secure e-commerce transaction based on the customer account number, wherein the customer account number identifies at least one of: a credit card number, name of credit card holder, expiration date, credit status, and available funds.

6. The method of claim 3, wherein the generating the temporary credit card number further comprises:
generating a random number;
accessing credit card data based on the customer account number, wherein the credit card data includes at least one of: a credit card number, name of credit card holder, and identity of a credit card financial institution; and
manipulating the credit card data by the random number to produce the temporary credit card number.

7. A method for secure e-commerce transactions, the method comprises:
detecting initiation of securing an e-commerce transaction;
providing a customer package regarding the securing of the e-commerce transaction to a server;
obtaining a temporary credit card number from the server for the securing of the e-commerce transaction; and
providing the temporary credit card number to consummate the e-commerce transaction.

8. The method of claim 7, wherein the detecting of the initiation of securing the e-commerce transaction further comprises:
detecting a designated string in a credit card number section of a merchant's e-commerce transaction form; and
interpreting the designated string to identify a customer account number for securing e-commerce transactions.

9. The method of claim 8, wherein the providing the temporary credit card number further comprises:
entering the temporary credit card number in the credit card number section of the merchant's e-commerce transaction form.

10. The method of claim 7, wherein the providing the customer package further comprises:
establishing a secure link with the server;
compiling at least one of a customer account number, a desired amount of the e-commerce transaction, identity of an e-commerce merchant, merchant account number, a password, and a login to produce the customer package;
encrypting at least some of the customer package based on a unique secure formula to produce an encrypted customer package; and
transmitting the encrypted customer package to the server via the secure link.

11. A method for establishing a secure e-commerce transaction account, the method comprises:
receiving a request for establishing a secure e-commerce transaction account;
validating authenticity of the request;
when the request is authentic:
generating a customer account number based on the request;
generating a unique formula and an inversion of the unique formula based on the request; and
providing the customer account number and the inversion of the unique formula in response to the request.

12. The method of claim 11, wherein the receiving the request further comprises:
receiving the request via a secure link from a customer application, wherein the request includes at least one of: identity of credit card holder, a credit card type, a credit card number, and a financial institution.

13. The method of claim 12, wherein the validating authenticity of the request further comprises:
communicating with the financial institution to verify the authenticity of the credit card holder, the credit card number, and associated credit card status.

14. The method of claim 12, wherein the generating the unique formula further comprises:
establishing a mathematical equation that incorporates digits of at least one of: the identity of the credit card holder, the credit card type, the credit card number, the financial institution, and an expiration date to produce the unique formula.

15. The method of claim 14, wherein the generating of the inversion of the unique formula further comprises:
establishing an inversion of the mathematical equation to retrieve the digits of the at least one of: the identity of the credit card holder, the credit card type, the credit card number, the financial institution, and an expiration date to produce the unique formula.

16. A digital storage device operable to store operational instructions that, when read by a processing module, causes the processing module to process the operational instructions, the digital storage device comprises:
first storage section that stores operational instructions that cause the processing module to receive a customer package of variables regarding a desired secure e-commerce transaction;
second storage section that stores operational instructions that cause the processing module to validate the desired secure e-commerce transaction based on at least one item of the package of variables;
third storage section that stores operational instructions that cause the processing module to, when the desired secure e-commerce transaction is validated, generate a temporary credit card number for the desired secure e-commerce transaction based on the at least one item of the package of variables; and
fourth storage section that stores operational instructions that cause the processing module to provide the temporary credit card number for use in the desired secure e-commerce transaction.

17. The digital storage device of claim 16 further comprises:
fifth storage section that stores operational instructions that cause the processing module to receive a debit request for the desired secure e-commerce transaction, wherein the debit request identifies the temporary credit card number;
sixth storage section that stores operational instructions that cause the processing module to validate the debit request; and
seventh storage section that stores operational instructions that cause the processing module to, when the debit request is valid, bill the desired secure e-commerce transaction to the corresponding credit card account.

18. The digital storage device of claim 16, wherein the first storage section further comprises:
fifth storage section that stores operational instructions that cause the processing module to receive the customer package via a secure link with a customer application, wherein the customer package includes at least one of: a customer account number, a desired amount of the desired secure e-commerce transaction, identity of an e-commerce merchant, merchant account number, a password, and a login; and
sixth storage section that stores operational instructions that cause the processing module to decrypt at least some of the customer package based on a unique secure formula associated with the customer account number.

19. The digital storage device of claim 18, wherein the second storage section further comprises:
fifth storage section that stores operational instructions that cause the processing module to authenticate a requesting entity of the desired secure e-commerce transaction based on at least the customer account number and the unique secure formula;
sixth storage section that stores operational instructions that cause the processing module to, when the requesting entity has been authenticated, determine credit card data based on the customer account number, wherein the credit card data includes at least one of: a credit card number, name of credit card holder, and identity of a credit card financial institution; and
seventh storage section that stores operational instructions that cause the processing module to communicate with the credit card financial institution to determine whether sufficient funds exist for the desired secure e-commerce transaction.

20. The digital storage device of claim 18, wherein the second storage section further comprises:
fifth storage section that stores operational instructions that cause the processing module to authenticate requesting entity of the desired secure e-commerce transaction based on at least the customer account number and the unique secure formula; and
sixth storage section that stores operational instructions that cause the processing module to, when the requesting entity has been authenticated, determine whether sufficient funds exist for the desired secure e-commerce transaction based on the customer account number, wherein the customer account number identifies at least one of: a credit card number, name of credit card holder, expiration date, credit status, and available funds.

21. The digital storage device of claim 18, wherein the third storage section further comprises:
fifth storage section that stores operational instructions that cause the processing module to generate a random number;
sixth storage section that stores operational instructions that cause the processing module to access credit card data based on the customer account number, wherein the credit card data includes at least one of: a credit card number, name of credit card holder, and identity of a credit card financial institution; and
seventh storage section that stores operational instructions that cause the processing module to manipulate the credit card data by the random number to produce the temporary credit card number.

22. A digital storage device operable to store operational instructions that, when read by a processing module, causes the processing module to process the operational instructions, the digital storage device comprises:
first storage section that stores operational instructions that cause the processing module to detect initiation of securing an e-commerce transaction;
second storage section that stores operational instructions that cause the processing module to provide a customer package regarding the securing of the e-commerce transaction to a server;
third storage section that stores operational instructions that cause the processing module to obtain a temporary credit card number from the server for the securing of the e-commerce transaction; and
fourth storage section that stores operational instructions that cause the processing module to provide the temporary credit card number to consummate the e-commerce transaction.

23. The digital storage device of claim 22, wherein the first storage section further comprises:
fifth storage section that stores operational instructions that cause the processing module to detect a designated string in a credit card number section of a merchant's e-commerce transaction form; and
sixth storage section that stores operational instructions that cause the processing module to interpret the designated string to identify a customer account number for securing e-commerce transactions.

24. The digital storage device of claim 23, wherein the fourth storage section further comprises:
fifth storage section that stores operational instructions that cause the processing module to enter the temporary credit card number in the credit card number section of the merchant's e-commerce transaction form.

25. The digital storage device of claim 22, wherein the second storage section further comprises:
fifth storage section that stores operational instructions that cause the processing module to establish a secure link with the server;
sixth storage section that stores operational instructions that cause the processing module to compile at one of a customer account number, a desired amount of the e-commerce transaction, identity of an e-commerce merchant, merchant account number, a password, and a login to produce the customer package;
seventh storage section that stores operational instructions that cause the processing module to encrypt at least some of the customer package based on a unique secure formula to produce an encrypted customer package; and
eighth storage section that stores operational instructions that cause the processing module to transmit the encrypted customer package to the server via the secure link.

26. A digital storage device operable to store operational instructions that, when read by a processing module, causes the processing module to process the operational instructions, the digital storage device comprises:
first storage section that stores operational instructions that cause the processing module to receive a request for establishing a secure e-commerce transaction account;
second storage section that stores operational instructions that cause the processing module to validate authenticity of the request;
third storage section that stores operational instructions that cause the processing module to, when the request is authentic:
generate a customer account number based on the request;
generate a unique formula and an inversion of the unique formula based on the request; and
provide the customer account number and the inversion of the unique formula in response to the request.

27. The digital storage device of claim 26, wherein the first storage section further comprises:
fourth storage section that stores operational instructions that cause the processing module to receive the request via a secure link from a customer application, wherein the request includes at least one of: identity of credit card holder, a credit card type, a credit card number, and a financial institution.

28. The digital storage device of claim 27, wherein the second storage section further comprises:
fourth storage section that stores operational instructions that cause the processing module to communicate with the financial institution to verify the authenticity of the credit card holder, the credit card number, and associated credit card status.

29. The digital storage device of claim 27, wherein the third storage section further comprises:
fourth storage section that stores operational instructions that cause the processing module to establish a mathematical equation that incorporates digits of at least one of: the identity of the credit card holder, the credit card type, the credit card number, the financial institution, and an expiration date to produce the unique formula.

30. The digital storage device of claim 29, wherein the third storage section further comprises:
fourth storage section that stores operational instructions that cause the processing module to establish an inversion of the mathematical equation to retrieve the digits of the at least one of: the identity of the credit card holder,
the credit card type, the credit card number, the financial institution, and an expiration date to produce the unique formula.

31. An apparatus for secure e-commerce transactions, the apparatus comprises:
processing module; and
memory operably coupled to the processing module, wherein the memory includes operational instructions that cause the processing module to:
receive a customer package of variables regarding a desired secure e-commerce transaction;
validate the desired secure e-commerce transaction based on at least one item of the package of variables;
when the desired secure e-commerce transaction is validated, generate a temporary credit card number for the desired secure e-commerce transaction based on the at least one item of the package of variables; and
provide the temporary credit card number for use in the desired secure e-commerce transaction.

32. The apparatus of claim 31, wherein the memory further comprises operational instructions that cause the processing module to:
receive a debit request for the desired secure e-commerce transaction, wherein the debit request identifies the temporary credit card number;
validate the debit request; and
when the debit request is valid, bill the desired secure e-commerce transaction to the corresponding credit card account.

33. The apparatus of claim 31, wherein the memory further comprises operational instructions that cause the processing module to receive the customer package by:
receiving the customer package via a secure link with a customer application, wherein the customer package includes at least one of: a customer account number, a desired amount of the desired secure e-commerce transaction, identity of an e-commerce merchant, merchant account number, a password, and a login; and
decrypting at least some of the customer package based on a unique secure formula associated with the customer account number.

34. The apparatus of claim 33, wherein the memory further comprises operational instructions that cause the processing module to validate the desired secure e-commerce transaction by:
authenticating requesting entity of the desired secure e-commerce transaction based on at least the customer account number and the unique secure formula;
when the requesting entity has been authenticated, determining credit card data based on the customer account number, wherein the credit card data includes at least one of: a credit card number, name of credit card holder, and identity of a credit card financial institution; and
communicating with the credit card financial institution to determine whether sufficient funds exist for the desired secure e-commerce transaction.

35. The apparatus of claim 33, wherein the memory further comprises operational instructions that cause the processing module to validate the desired secure e-commerce transaction by:
authenticating a requesting entity of the desired secure e-commerce transaction based on at least the customer account number and the unique secure formula; and
when the requesting entity has been authenticated, determining whether sufficient funds exist for the desired secure e-commerce transaction based on the customer account number, wherein the customer account number identifies at least one of: a credit card number, name of credit card holder, expiration date, credit status, and available funds.

36. The apparatus of claim 33, wherein the memory further comprises operational instructions that cause the processing module to generate the temporary credit card number by:
generating a random number; accessing credit card data based on the customer account number, wherein the credit card data includes at least one of: a credit card number, name of credit card holder, and identity of a credit card financial institution; and
manipulating the credit card data by the random number to produce the temporary credit card number.

37. An apparatus for secure e-commerce transactions, the apparatus comprises:
processing module; and
memory operably coupled to the processing module, wherein the memory includes operational instructions that cause the processing module to:
detect initiation of securing an e-commerce transaction;
provide a customer package regarding the securing of the e-commerce transaction to a server;
obtain a temporary credit card number from the server for the securing of the e-commerce transaction; and
provide the temporary credit card number to consummate the e-commerce transaction.

38. The apparatus of claim 37, wherein the memory further comprises operational instructions that cause the processing module to detect the initiation of securing the e-commerce transaction by:
detecting a designated string in a credit card number section of a merchant's e-commerce transaction form; and
interpreting the designated string to identify a customer account number for securing e-commerce transactions.

39. The apparatus of claim 38, wherein the memory further comprises operational instructions that cause the processing module to provide the temporary credit card number by:
entering the -temporary credit card number in the credit card number section of the merchant's e-commerce transaction form.

40. The apparatus of claim 37, wherein the memory further comprises operational instructions that cause the processing module to provide the customer package by:
establishing a secure link with the server; compiling at one of a customer account number, a desired amount of the e-commerce transaction, identity of an e-commerce merchant, merchant account number, a password, and a login to produce the customer package;
encrypting at least some of the customer package based on a unique secure formula to produce an encrypted customer package; and
transmitting the encrypted customer package to the server via the secure link.

41. An apparatus for establishing a secure e-commerce transaction account, the apparatus comprises:
processing module; and
memory operably coupled to the processing module, wherein the memory includes operational instructions that cause the processing module to:
receive a request for establishing a secure e-commerce transaction account;
validate authenticity of the request;
when the request is authentic:
generate a customer account number based on the request;
generate a unique formula and an inversion of the unique formula based on the request; and
provide the customer account number and the inversion of the unique formula in response to the request.

42. The apparatus of claim 41, wherein the memory further comprises operational instructions that cause the processing module to receive the request by:
receiving the request via a secure link from a customer application, wherein the request includes at least one of: identity of credit card holder, a credit card type, a credit card number, and a financial institution.

43. The apparatus of claim 42, wherein the memory further comprises operational instructions that cause the processing module to validate authenticity of the request by:
communicating with the financial institution to verify the authenticity of the credit card holder, the credit card number, and associated credit card status.

44. The apparatus of claim 42, wherein the memory further comprises operational instructions that cause the processing module to generate the unique formula by:
establishing a mathematical equation that incorporates digits of at least one of: the identity of the credit card holder, the credit card type, the credit card number, the financial institution, and an expiration date to produce the unique formula.

45. The apparatus of claim 44, wherein the memory further comprises operational instructions that cause the processing module to generate the inversion of the unique formula by:
establishing an inversion of the mathematical equation to retrieve the digits of the at least one of: the identity of the credit card holder, the credit card type, the credit card number, the financial institution, and an expiration date to produce the unique formula.
